(19) United States
(12) Patent Application Publication
(10) Pub. No.: US 2006/0139630 A1
(43) Pub. Date: Jun. 29, 2006

(54) Standard light source for single photo count apparatus

(75) Inventors: Jinsheng Yu, Beijing (CN); Jiang Lan, Beijing (CN); Xiaolin Yang, Beijing (CN); Xiaodong Wu, Beijing (CN)

Correspondence Address: DARBY & DARBY P.C., P. O. BOX 5257, NEW YORK, NY, 10150-5257, US

(73) Assignee: Beijing Yuande Bio-Medical Engineering Co., Ltd., Beijing (CN)

(21) Appl. No.: 11/040,610

(22) Filed: Jan. 19, 2005

Related U.S. Application Data
(63) Continuation of application No. PCT/CN04/01507, filed on Dec. 23, 2004.

(51) Int. Cl. G01J 1/10

(52) U.S. Cl. 356/243.8

(57) ABSTRACT

A standard light source for single photon count apparatus, comprising: a housing; a light emitting diode; a light-shielding plate, disposed above said light emitting diode, for weakening the light intensity emitted by the light emitting diode; and a light-shielding filler for blocking the light emitted by the light emitting diode propagating downward, said light shielding filler, said light shielding plate and said LED are sealed in said housing integrally.

### FIELD OF THE INVENTION

The application relates to single photon count apparatus, particularly to a standard light source for single photon count apparatus.

### BACKGROUND OF THE INVENTION

Test for various hormones, medicines, vitamins, tumors or infection-associated substance is a basic work for a hospital. Traditional radioactive immunoassay has some drawbacks, since it is of short half life, difficult to store, harmful to the operator and the environment, and has low sensitivity. In 1990's of 20th century, photo bio-marker test method is developed with chemical luminescence, which has advantages in simplicity, efficiency and safety, and has high sensitivity. The method is now applied to clinic diagnosis.

A single photon counting apparatus is a detecting device for detecting a reagent with chemical luminescence, which is used to detect the very weak light intensity emitted by the processed sample with single photon counting method.

Compared with traditional radioactive immunoassay, the single photon counter apparatus has, when used to test various hormones, medicines, vitamins, tumors or infection-associated substance in a hospital, advantages in simplicity, efficiency and safety, and has high sensitivity.

In order to ensure the stability of the output data of a single photon count apparatus, it is necessary to calibrate the apparatus with a standard light source. The standard light source must emit a visible light within some wavelength range suitable for the intensity range detected by the single photon count apparatus, and the emission intensity of the standard light source must have long-term stability within some temperature range. Since the detected emission intensity is very weak (the minimum count value is less than 100 s⁻¹), a conventional light source cannot be directly used as the standard light source due to its emission intensity far higher than the detected emission intensity. Alternatively, although a standard light source can be made in standard sample way, its emission intensity is stable only for a short time, which cannot meet requirements for calibrating the single photon count apparatus in mass production. Furthermore, a standard light source may be made from a scintillation crystal doped with Carbon-14, which can meet the requirements for emission intensity and stability. However, the manufacturing cost of the standard light source is expensive. The emission mechanism belongs to multiple photon emission event in quantum theory, which is not in compliance with the single photon emission event of the tested sample of the count apparatus, and the distribution of the emission intensity is not uniform. The standard light source includes radioactive material, which is harmful to human body and the environment. The standard light source is not suitable for application of calibration light source.

### SUMMARY OF THE INVENTION

An object of the invention is to provide a specific standard light source for calibrating single photon count apparatus.

In accordance with one aspect of the invention, a standard light source for single photon count apparatus, comprising: a housing; a light emitting diode; a light-shielding plate, disposed above said light emitting diode, for weakening the light intensity emitted by the light emitting diode; and a light-shielding filler for blocking the light emitted by the light emitting diode propagating downward.

In accordance with second aspect of the invention, wherein said LED is a blue light emitting diode.

In accordance with third aspect of the invention, wherein said LED is a green light emitting diode.

In accordance with fourth aspect of the invention, wherein said light-shielding plate is a black thin sheet with a small central hole.

In accordance with fifth aspect of the invention, wherein said light-shielding plate is a translucent sheet coated with a light shielding layer.

In accordance with sixth aspect of the invention, wherein said standard light source further comprising a voltage stabilizing circuit for stabilizing the emission intensity of said LED.

In accordance with seventh aspect of the invention, wherein said standard light source further comprising a current stabilizing circuit for stabilizing the emission intensity of said LED.

In accordance with eighth aspect of the invention, wherein said standard light source further comprising a power stabilizing circuit for stabilizing the emission intensity of said LED.

In accordance with ninth aspect of the invention, wherein said standard light source further comprising a voltage stabilizing circuit, a current stabilizing circuit and a power stabilizing circuit for stabilizing the emission intensity of said LED.

The light emission mechanism and the spectral region of the standard light source of the invention are in compliance with the single photon emission event of the detected sample of the count apparatus. The light intensity and the stability of the standard light source of the invention can meet the requirements of the art. The standard light source of the invention has advantageous size, weight, power consumption and cost relative to other standard light source in the art.

### BRIEF DESCRIPTION OF THE DRAWING

The foregoing and other advantages of the invention will become apparent upon reading the following detailed description and upon reference to the drawings in which:

FIG. 1 shows an arrangement of the standard light source for single photon counting apparatus in accordance with an embodiment of the invention.

### DETAILED DESCRIPTION OF THE INVENTION

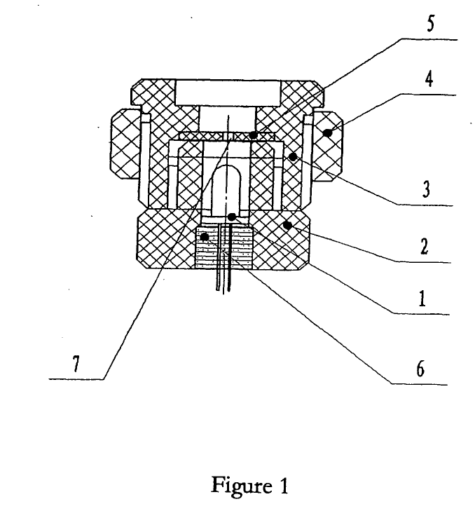

As shown in FIG. 1, in accordance with an embodiment of the standard light source for single photon count apparatus, the light emitted by light emitting diode (LED) 1 is used to calibrate a single photon count apparatus. LED 1 may be a blue LED or a green LED. Light shielding plate 5 is disposed above LED 1. The light shielding plate weakens the light intensity emitted by the light emitting diode and makes the light outputting from it distributed uniformly. Said light shielding plate may be a black thin sheet with small central hole 7 or a translucent sheet coated with a light-shielding layer. A light-shielding filler 6 is filled in the lower space under said LED, which blocks the light emitted by the LED propagating downward and reduces the stray light in the system. LED 1, light shielding plate 5 and light shielding filler 6 are sealed in housing 2, 3, 4 integrally. Furthermore, a standard light source for single photon count apparatus of the invention may further comprises a voltage stabilizing circuit, a current stabilizing circuit or/and a power stabilizing circuit for stabilizing the emission intensity of said LED (not shown in the Figure).

An arrangement of standard light source for single photon count apparatus has been disclosed in accordance with an embodiment of the invention. One of ordinary skill in the art will readily recognize that there could be variations to the described embodiment and those variations would be within the spirit and the scope of the present invention. Accordingly, many modifications may be made by skilled person in the art without departing from the spirit and scope of the appended claims.

1. A standard light source for a single photon count apparatus, comprising:
a housing;
a light emitting diode;
a light-shielding, plate disposed above said light emitting diode, for weakening the light intensity emitted by the light emitting diode; and
a light-shielding filler for blocking the light emitted by the light emitting diode propagating downward; said light shielding filler, said light shielding plate and said LED being sealed in said housing integrally.

2. The standard light source of claim 1, wherein said LED is a blue light emitting diode.

3. The standard light source of claim 1, wherein said LED is a green light emitting diode.

4. The standard light source of claim 1, wherein said light-shielding plate is a black thin sheet with a small central hole.

5. The standard light source of claim 1, wherein said light-shielding plate is a translucent sheet coated with a light-shielding layer.

6. The standard light source of claim 1, further comprising a voltage stabilizing circuit for stabilizing the emission intensity of said LED.

7. The standard light source of claim 1, further comprising a current stabilizing circuit for stabilizing the emission intensity of said LED.

8. The standard light source of claim 1, further comprising a power stabilizing circuit for stabilizing the emission intensity of said LED.

9. The standard light source of claim 1, further comprising a voltage stabilizing circuit, a current stabilizing circuit and a power stabilizing circuit for stabilizing the emission intensity of said LED.
